(19) United States
(12) Patent Application Publication
(10) Pub. No.: US 2018/0187083 A1
(43) Pub. Date: Jul. 5, 2018

(54) METHOD OF MANUFACTURE AND APPLICATIONS FOR FIRE RETARDANT, HEAT, FUNGI, AND INSECT RESISTANT, AND STRENGTH ENHANCING ADDITIVE

(71) Applicant: Siqing Song-Destro, Deland, FL (US)

(72) Inventors: Siqing Song-Destro, Deland, FL (US); David Gomez, New Smyran Beach, FL (US)

(21) Appl. No.: 15/580,706

(22) PCT Filed: Jul. 13, 2016
(86) PCT No.: PCT/US16/41997

§ 371 Date: Dec. 8, 2017

Related U.S. Application Data
(60) Provisional application No. 62/192,744, filed on Jul. 15, 2015.

(51) Int. Cl. C09K 21/02; A01N 59/06; A01N 59/16; A01N 59/00; C09D 5/18; C09D 5/14; C09D 1/00; B05D 3/10; B05D 3/00

(52) U.S. Cl. CPC C09K 21/02; A01N 59/06; A01N 59/16; A01N 59/00; B05D 3/007; C09D 5/14; C09D 1/00; B05D 3/107; C09D 5/18

(57) ABSTRACT

A non-toxic, and environmentally safe additive, a method of manufacture, and application thereof. The additive is comprised of a mild aqueous acid solution including halogen acids, elemental aluminum, a transition metal, such as chromium (III) and water, such as tap water or sea water. The additive can be applied to wood, wood-based products, textile, plastics, wallboards, paper and paper products, paints and coatings, insulation materials, cement and asphalt, or any materials that are organic or inorganic that are either porous or can be mixed with other liquid based materials, and serve as an effective fire retardant, heat, fungi, and insect resistant as well as a strength enhancer. The additive can be produced in either a liquid or solid form, or any form ranging from liquid to solid.

The present application claims priority from U.S. Provisional Patent Application Ser. No. 62/192,744 filed on Jul. 15, 2015, the disclosure of which is incorporated herein by reference in its entirety.

### DESCRIPTION

### 1. Field of the Invention

“Fire retardant” refers to standardized scientific measures, including flame spread, heat transfer and smoke density, and surface flammability.

“Heat resistant” means that the additive will transfer less heat to the treated materials, enabling the treated materials to tolerate higher temperatures from sources such as flame and fire, and to tolerate a longer time period of heat exposure.

“Fungi resistant” means resistant to attack by fungi, bacteria and moisture, including mold and mildew.

“Insect resistant” means resistant to attack by insects such as termites.

“Non-toxic” refers to acute dangers to humans and the natural environment, resulting from emission, sourcing of raw materials, production, construction, use (including environmental stress by UV light, wind and water), removal and disposal.

“Strength enhancer,” means that materials treated with this additive often exhibits more resistance to pressure, impact, or other forms of aggression.

This invention relates to a new additive, method of manufacturing, and applications thereof. The additive, in addition to being non-toxic to humans, animals, and the natural environment, provides a broader spectrum of benefits than most known commercial competitors. It exhibits fire, fungal, insect, and heat resistance, in addition to strength-enhancing the material on which the additive is applied. Further, the additive transfers less heat to the material on which it is applied, enabling it to tolerate higher temperatures for a longer period of time of heat exposure.

This additive can be applied to a wide range of materials, including but not limited to wood, particle board/Masonite, gypsum drywall, insulating materials, paints and coatings, plastics, upholstery and textiles; cement products and asphalt products such as for highway and bridges.

Experiments on this additive's use, efficacy, and safety involved its application to materials such as lumber, paint, drywall, cement products, textiles, certain plastics such as PVC, and insulating materials, which support its use in a wide range of industries. For example, the additive could be applied to construction materials (e.g., lumber, cement products, asphalt based products), military uniforms and structures, firefighting equipment, highways, bridges, upholstery for airplanes, trains and cars, and commercial or residential furniture.

Many industries, especially ones that require fire and fungi prevention, are in need of an economical, safe, and non-toxic product replacement to the current market alternatives. In fact, many of the presently available products for such purposes contain harmful, caustic or even poisonous chemicals.

Further, industries that require structurally sound and strong materials, such as cement and asphalt, for activities such as highway and bridge building, lack an effective all-in-one and single application product that can increase the strength and durability of such materials, in addition to acting as a non-toxic fire, heat, fungi, and insect resistant.

### 2. Description of Related Art

This additive offers competitive advantages to the related market, as it offers a superior profile of benefits at the same or lower cost as existing market products. For example, this additive uniquely combines, in an all-in-one product and single-treatment, features such as fire retardant, fungi, insect, and heat resistance, in addition to strength enhancement. Further, its manufacturing method is cheaper and more efficiently produced than comparable products and/or treatments currently used on the market. All required production materials for this additive (aluminum, transition metal, mild acids and water) are easily obtainable and affordable. Additionally, no major changes or alterations need to be made to current market application processes to accommodate this additive's application.

In terms of safety, this additive is safer for the environment, humans and animals than most current market alternatives. It contains nearly no toxicity, nor does it create and/or emit any toxicity at any time during the life of the product. In contrast, for example, many current market products for fungi resistance, rely on heavily toxic materials, such as chromated copper arsenate (CCA), boron additives and copper salts.

Additionally, many currently available fire retardants contain boron, phosphate, nitrogen, copper or formaldehyde, which can be toxic if exposed to humans or animals via burning of treated materials, seepage from the treated materials, or other means of release.

Further, there are additional drawbacks for most current market fire retardants. For example, treatments that contain formaldehyde require excessive drying, which partially activate the fire retardant, reducing its effectiveness. Further, boron and phosphates are hazardous in handling as well as transportation, which presents safety and health issues for a company's use, production, and/or transport of them. Moreover, many currently-available fire retardants require more than one application in order to be fully protected. Each application saturates the wood with increasing levels of dangerous chemicals, in addition to the added financial cost.

Additionally, some current market additives require an application of resin to seal-in the fire retardant, which poses further health and environmental risks. Specifically, by sealing-in the additive, the fire needs to melt or burn away the resin before the fire retardant additive can take effect, which, when ignited, can release into the air harmful properties stored in the resin. For example, these resins often contain urea, which contains ammonium and carbon dioxide, and can be harmful when burned. Furthermore, these resins often increase the corrosion rates of metal.

Lastly, many market available fire retardants often reduce the treated material's utility and aesthetic lifespan. Such a lifespan reduction results from discoloration and degradation, caused by the combination of its application and prolonged exposure to rain, sun and humidity. For example, wood products used for structural purposes are particularly susceptible to these concerns. Another way such a lifespan reduction occurs includes the oft-required small perforations in the treated wood, in order to assure adequate penetration of the fire retardant composition, which can reduce the treated wood's structural integrity. In contrast, due to its unique composition, this additive can increase the strength and durability of the treated materials. No other current market product combines such a quality with the ability to provide a non-toxic fire, heat, fungi, and insect resistant additive.

Further, this additive contains no harmful ingredients, in contrast to current market alternatives, such as certain fungus treatments that use copper and arsenic. Moreover, this additive does not contain known toxins, nor generates any gaseous emissions known to be toxic.

In terms of insect resistance, current market products mainly consist of harmful materials such as chromated copper arsenate (CCA), alkaline copper quaternary (ACQ), copper CBA (Boron Azole), ammoniacal copper zinc arsenate (ACZA), borates and copper azole borate (CAB). The EPA labeled these materials ecologically and biologically toxic, thereby rendering them unsafe for the environment and animal life.

At present, there is a strong need for a copper-free product. For example, CCAs are being phased out for residential use due to human toxicity issues. Moreover, even though ACQs are widely used and considered the “green” market standard, there are potential health and environmental concerns associated with the use of copper in ACQ.

### 4. Object of the Invention

It is therefore an object of the present invention to create fire retardants, which are non-toxic, non-hazardous, and non-volatile.

It is a further object of the present invention to create fire retardants that are safe to store, safe to handle, and safe to transport.

It is a further object of this present invention to create fire resistant additives, which contain aluminum in higher purity, halogen acid including hydrochloric acid, water and trace amounts of transition metals including Cr III. These materials allow for the formations of, for example, AlCl₃, AlOH₃ and H₂.

Additionally, it is still a further object of the present invention to create fire, heat, fungi and insect resistant additives that when used to treat materials such as but not limited to, wood and wood-based products, render them fire resistant, unable to be ignited, potentially slowing and/or snuffing out the flame.

It is another object of the present invention to create fire, heat, fungi and insect resistant additives, which can be used to treat materials including wood, textiles, paper, insulation materials, plastics such as PVC, paint and coatings, foams, wallboards and roofing materials.

It is yet another object of the present invention to create fire, heat, fungi and insect resistant additives which can be applied to many industries in addition to the wood or wood related industries.

It is yet another object of the present invention to create fire, heat, fungi and insect resistant additives that can be easily and consistently produced in large quantities.

It is another object of the present invention to create fire, heat, fungi and insect resistant additives, which are stable over a wide range of temperatures, have a long shelf life, can be easily and safely handled, and transported.

It is yet another object of the present invention to create, heat, fungi and insect resistant additives that utilize aluminum or other metals of similar kinds, hydrochloric acid or other halogen acids, and chromium (III) or other transition metals, and uncontaminated water including tap water and seawater.

It is a still further object to create fire, heat, fungi and insect resistant additives that are easy to use, non-toxic, easy to apply and in most cases require no or minimal alteration to current equipment set ups.

It is yet further still an object to create fire, heat, fungi and insect resistant additives that can be applied in only a single application process to treat the intended materials to accomplish fire, heat, fungi and insect resistance.

It is also an object of this present invention to create fungi resistant additives that exhibit superb mold and mildew resistance.

It is another object of this present invention to create a fungi resistant additives that, when burned, produce little to nearly no additional fumes or smoke compared to original control samples (untreated wood) of tests conducted for this purpose.

It is another object of this present invention to create insect resistant additives that exhibit superior insect resistance, including termite resistance.

It is another object of this present invention to create insect resistant additives that cause starvation and therefore death to termites that are exposed and surrounded by the environment created with this additive if the termites are entrapped within such environment.

It is additionally another object of this present invention to create insect resistant additives that deter termites that are exposed by the environment created with this additive.

It is still an object of the present invention to create fire, heat, fungi and insect resistant additives that can increase the strength and durability of the treated materials.

It is still an object of the present invention to create fire, heat, fungi and insect resistant additives that can be created on a laboratory scale and scale up to manufacturing size.

### 3. SUMMARY OF THE INVENTION

This additive contains a mild aqueous acidic solution including aqueous halogen acid solution (about pH 2-5) infused with a minor amount of high purity aluminum (about 99.90% to 99.99%), and trace amount of non-toxic transition metal including chromium III.

Tests have shown that this additive renders treated materials, of which the inventor tested with plywood most extensively, a Class A (ASTM E-162) fire retardant; a 0 rating (ASTM G-21) fungi resistant; termite resistant (as tested by ASTM D3345-08/ AWP E1-13), and non-toxic (supported by the ASTM BSS 7239 test, showing that the emissions given off by the samples were almost identical to the original untreated wood control samples, generating no toxic emissions).

The ASTM E162 test proved this additive to be a Class A fire retardant with a 3-7 rating (The ASTM E162 test is a standard scientific test of surface flammability where less than 25 is regarded as Class A). For comparison, untreated control samples of wood or plywood rated Class C or worse, and failed the E162 test almost immediately.

This additive, may include aluminum hydroxide and aluminum chloride, which may contribute to fire retardant effects (“Metal hydroxides act as fire retardants by releasing water vapor through endothermic decomposition, leaving a thermally stable inorganic residue.” Hollingbery, L. A. and T. R. Hull. “The Fire Retardant Behavior of Huntite and Hydromagnesite—A Review.” In Polymer Degradation and Stability, Volume 95, Issue 12, pg 2213-2225, 2010.). Aluminum chloride will release the chloride ions and hydrochloric acid (HCL) as a vapor and gas. This reaction suggests a triple mechanism for the additive, whereby the hydroxide helps to serve as a fuel diluent (release of water), which also helps keep the wood cool so that it does not decompose, while the HCL likely serves as a vapor phase flame retardant to inhibit combustion. This combined mechanism appears to be supported based upon observations during E162 testing, where the flame was snuffed out, and possibly leaving behind the aluminum oxide to stay as an inert residue/filler which may further slow combustion/pyrolysis of the wood (as an ancillary fourth mechanism).

Chromium can also contribute as a partial fire resistant (“Transition metal complexes have been used for quite some time as fire retardant smoke suppressants (FRSS) for poly (vinyl chloride). Use of tris (2,4 pentanediono) chromium III has been examined as FRSS in PVC. The effectiveness of the FRSS is described in term of various fire properties, namely smoke release, flammability, time of ignition, heat release and generation of combustion products using a cone calorimeter and limiting oxygen index apparatus. It was found effective.” Sharma, Sunil K and S K Srivastava. “Tris (2,4-Pentanediono) ChromiumIII—A Fire Retardant Smoke Suppressant for Plasticized Poly(Vinyl Chloride).” Roorkee, India: Fire Research Laboratory, CSIR-Central Building Research Institute, 2012). This could potentially explain the contribution of Cr (III) in this invention additive for retarding flames and reducing smoke.

Further, the ASTM G21 test rendered all sample pieces treated with the additive an exemplary rating of 0 (The ASTM G21 test is an antifungal test, whereby its scale runs as follows: 0=no growth; 4=growth, completely covered sample.). Such results indicate that the sample had no fungus growth and contains no harmful ingredients, in contrast to current market copper- and arsenic-based products.

Hydrochloric acid, which is used in the present additive, is a low molecular weight acid that acts as a membrane permeability disruptor of the treated materials. (See George Chen, “Treatment of Wood with Polysilicic Acid, Wood and Fiber Science, July 2009, V. 41, p 220-228). Furthermore, the AlCl₃ in the subject invention possibly could be changing the hydroxyl substrate of the wood, preventing the fungi from growing.

Additionally, aluminum in this additive acts similar to copper in copper salts in preventing the growth of fungus in wood. “Copper oxidizes proteins, enzymes, and lipids and interferences with enzymatic processes” (Chen, “Laboratory Evaluation . . . ”, op. cit.)

Also, the moisture content in the wood treated with this additive is not high enough for fungus growth, as this additive displaces and replaces the water within the treated wood.

The fungal resistance may result from the filling of the holes in the wood's cell membrane, creating an impermeable layer making the substrate inhospitable to fungi.

Overall, the testing has indicated strongly that this invention can retard and prevent fungi growth.

Testing has also shown that this additive does not contain known toxins, nor are any gaseous emissions known to be toxic. When treated wood samples were burned via the ASTM BSS 7239 test, the sample's gaseous emissions were almost identical to the emissions of the original untreated wood control sample.

This additive consists of 4 basic parts: aluminum or other types of metal with similar properties; chromium [non-toxic form of chromium, Cr(III)] or other kinds of transitional metals; an aqueous solution with a pH between 2 and 5 but preferably between 3-4 with acids that include hydrochloric acid or other halogen acids; and water including tap water and seawater.

Termites survive by finding sources of food or cellulose in plants, trees and wood-based products. Aluminum in this additive may prevent termites from doing so, as it potentially binds with the cellulose(C₆H₁₀O₅)n in wood, therefore changing the substrate that termites find appealing.

The aqueous solution also has some potential anti-termite protection by changing the pH of wood, which typically ranges from approximately 4 to 7, to a more acidic level. Such an acidic change may force termites to find wood treated with this additive less appetizing. Acids may change or interfere with the cellulose chain of wood by adding elements from the acids such as chlorine, which could further deter termite from attacking the wood by disrupt the environment of the wood with which termites are more familiar.

The aluminum in the subject additive is in such a minor amount (1% to 6% by weight) and is in elemental form, which causes no harm environmentally or to human and animals. The percentage of aluminum contained in the additive is approximately 1% to 6% by weight, but preferably between 1% to 3%, and the percentage of the additive absorbed by the treated wood for example is approximately 15% to 24% by weight, but most likely about no more than 20%.

The trace amount (less than 1%) of transitional metal such as chromium (III) is non-toxic and often used by itself or combined as a supplement, safe for human, animals and the environment.

Smoke toxicity tests such as BSS 7239 showed nearly no increase in NO₂ and SO₂ emissions (standard deviation 5 ppm) with this subject invention additive.

In terms of safety and toxicity, this additive displays a favorable spectrum of characteristics, including ones relating to human and environmental exposure. For example, this additive's non-toxic properties benefit all levels of human exposure such as sourcing of materials, production, or installation. In addition, regarding environmental exposure, this additive interacted favorably with other materials such as paint and lacquer, and poses no known environmental risks that would prevent a person's removal and disposal of treated materials.

When burned, this additive can and in many cases snuff out the flame via the seeping water vapors. Moreover, there is no additional toxicity contained within the smoke and vapor, nor the amount of smoke given off, compared to untreated wood control samples, as tests have shown.

This additive is safe and non-toxic throughout its sourcing, production, application, storage, transportation, usage and the disposal of the treated materials such as treated wood.

### 5. DETAILED DESCRIPTION

It is to be understood that the figures and descriptions of the present invention have been simplified to illustrate elements that are relevant for a clear understanding of the present invention, while eliminating, for purposes of clarity, many other elements which are conventional in this art. It is to be understood throughout this specification that the various descriptions therein are not to be construed as in any way limiting the scope or applicability of the present invention. Numerous embodiments and variations of the present invention will suggest themselves to those skilled in the art upon a careful study and understanding of the aforementioned drawings, and the principles and discoveries explained herein. In addition, it is to be understood that the details set forth in the preceding and following descriptions are not in themselves limitations upon the present invention, but merely describe the embodiments of the invention preferred by the inventors.

The additive is easy to produce from widely available and economical raw materials.

The additive is also safe to store, transport, and handle. It is non-toxic, non-hazardous, and non-volatile. In addition, the additive is easy to apply, and requires no major installation of new equipment or alteration to the existing application system, in most cases.

The manufacturing of this additive begins with a metal such as a piece or pieces of high purity aluminum subjected to a chemical bath such as an acid bath of about at 3 normality with water and halogen acids including tap water and hydrochloric acid; removing any oxide film or coating which may be present on the surface of the subject aluminum. Many acid solutions are known to be capable of removing surface oxide and films. Hydrochloric acid (HCL) is a preferred choice in this case, and its strength could be about 28% to 38%.

The oxide-free metal such as aluminum may then be immersed in a bath of acid water solution with a normality of 1N or 2N, that has been infused with about as little as 5 g to as much as 20 g of transitional metal such as chromium (III) to about 100 gallons of water and acid solution.

As the reaction of the aluminum in acid bath continues, the particles in the slurry begin to loosely bind together, changing the color of the slurry to a light green. Throughout the entire process, care should be taken to keep the pH of the reaction constant (pH 2-5). If at any time the pH abruptly shifts or changes towards either direction, it may be brought back into balance with the addition of acid or water.

As the slurry reaches the correct conditions, which is often judged by testing its density as an example, the desired number for density is about 10-20 cps (it roughly takes about 10 to 16 days). At that point, the slurry would have changed to a darker green color. Once the conditions are met, the slurry can then be collected, stored and applied to any suitable materials.

Once a sample of material has been treated with the slurry, the treated material can be naturally dried in the atmosphere; it can be dried with a drying mechanism such as a drying vent or oven; and it can also undergo a drying process using chemicals. This chemical-drying process requires that the sample be quickly submerged and completely cover the surface of the subject sample (from few seconds to less than one minute in most cases) in a drying solution including aqueous Magnesium Sulfate or Potassium Hydroxide. Once it is submerged and completely covered in the solution for long enough time for the subject treated material to be saturated with the solution penetrating at least the surface of the subject treated material, the treated material is then taken out to dry, either in the atmosphere or using a drying mechanism such as a drying vent or oven.

It should be noted that when ordinary commercial grade aluminum is introduced into a hydrochloric acid (HCL) solution (e.g. of normality 1N to 2N), the formation of aluminum chloride (and water), and other aluminum compounds occurs.

Further, the solution at least contains: the reaction product of the aluminum and hydrochloric acid in solution (e.g., Al+++Cl—H+ and OH ions in minor trace amount); and “activated aluminum”, probably in a colloidal suspension. “Activated aluminum” means aluminum containing naturally contained not manually added silicon as impurities in the aluminum preferably in the amount of 40 ppm to 150 ppm. It is observed by the applicant that when the subject aluminum for the purpose of producing this additive contains at least a trace amount of naturally contained silicon as impurity, especially the hexagonal “activated” form of silicon, in amounts about 40 ppm to about 150 ppm, the production of the additive becomes more “lively” with more active reactions and allows a faster production process.

The application of the complex of the present invention will accomplish fire, fungi, heat and insect resistance. The additives application is easily manageable and, with minor changes, readily applicable to existing such applications.

According to this invention, the aluminum complex slurry consists essentially of hydrogen, oxygen, chlorine and minor amounts of aluminum with chromium, iron and silicon as impurities, most likely as suspension in an acid water solution.

The complex can be prepared by the following sequence of steps: 1) Contacting an aluminum metal, having a purity preferably on the order of at least 99.90% by weight and including at least a trace amount of silicon and iron, with a strong concentrated source of acid that will remove and inhibit the formation of oxide thereon; 2) Immersing said aluminum in an acidic solution, containing halogen and a transitional metal such as CrIII, to effect a “brewing” of additive complex from said aluminum in said halogen-acidic solution, at a temperature of between ambient and not more than about 30° C.; 3) Adjusting or adding to the acidic halogen solution so as to maintain the same or near same quality and quantity; 4) Collect the additive solution to treat desired materials, or alternatively, the additive solution can be “dehydrated” into a more solid state of form and stored or transported for later use. 5) The ready-to-use collected additive can then be applied to desired materials to accomplish either singularly or in combination the purpose/purposes of fire resistance, fungi resistance, heat resistance and/or insect resistance; and 6) Drying the additive treated materials either by room temperature ambience or with a heating mechanism or with appropriate chemicals such as aqueous Magnesium Sulfate or Potassium Hydroxide; and finally 7) drying the final treated materials either by ambient room temperature or with a heating mechanism.

The silicon chromium chlorine containing aluminum complex of this invention can be conveniently prepared and applied, using a seven stage process, although the process is not to be narrowly construed as being limited to such.

The first stage (i.e., “Stage One”) is the preparation of a material containing silicon impurities (in the preferred embodiment, the material is a form of aluminum), and can typically be carried out as follows.

Utilizing the apparatus in FIG. 1, aluminum bar, rod or pellets 1 is/are placed as shown in vessel 3. The vessel 3 is constructed from acid-resistant heat resistant material, (preferably a plastic of some sort or of glass or Plexiglas®), and a layer of halogen acid 2 is placed in the vessel 3 so as to completely cover the aluminum. In this context, the shape of the aluminum is not critical. However, multiple smaller sized pieces of aluminum such as pellets are preferred order to create a greater surface of reaction and allow more action of agitations of the aluminum surfaces. The purpose of this acid treatment is to remove and to inhibit the formation of oxide on the aluminum surface. Hydrochloric acid of the strength/normality of 3N is the preferred acid employed for this purpose.

The aluminum should be substantially pure but not 100% pure, on the order of at least, but not limited to, 99.90% pure, and also ideally should contain amounts of silicon on the order of trace amount to about 40 ppm to about 150 ppm. As a practical matter, whether or not the aluminum is sufficiently pure can be empirically determined, since an abrupt rise in the temperature (typically caused by impurities reacting with the acid solution) indicates oxide formation and that the aluminum starting material is not sufficiently pure. Such a rise in temperature because of the impurities is usually seen in the growth phase using a lower normality acid solution, since the higher normality of the acid in the cleaning/inhibiting stage may cause a violent reaction irrespective of the aluminum purity. Therefore, for the purpose of this application, the term “substantially” is empirically determinable so as to be capable of being used in the process of this invention.

The small amount of impurity is desired especially impurities such as silicon and iron, and a 2:1 ratio of silicon and iron is most ideal though not absolutely necessary.

The aluminum is sufficiently clean when a shiny and reflective layer of aluminum is visible, as one way of judging the completion of “Stage One”. This process should take place in the presence of any oxygen-containing atmosphere, such as air. The temperature is not narrowly critical, but should not be such as to encourage oxide formation and or chlorine gas. For example, a temperature of greater than about 40° C. would generally encourage oxide formation and or chlorine gas, and therefore be undesirable. Ambient temperature is satisfactory.

In “Stage Two”, the formation of the complex begins. This stage involves the creation of the slurry, via a secondary acidic solution of a halogen acid of some sort and a type of water, mixed with a transition metal as seen in FIG. 2.

In the case of the “Stage Two” acidic solution, halogen acid specifically hydrochloric acid (HCL) is suitable.

In the case of “Stage Two” acidic solution water, tap water, seawater or any other clean water, meaning without major contaminants, is suitable.

The strength of this “Stage Two” acidic solution should be about 1 Normality to about less than 3 Normality. 2 Normality has been preferred in most cases. The halogen acid should have strength/normality of about 1 normal (“N”) to about 2 N, but the actual range of concentration is empirical.

In the case of “Stage Two” transition metal, Chromium III (Cr₃) is the preferred choice. The amount of Cr₃ to be added into the “Stage Two” halogen acid solution is in trace amounts of as less than or about 0.01% by weight, though amounts as high as about 1% or higher can as well be workable.

A gaseous build up may occur when contacting the acid and transition metal, however it will subside in a short time such as few seconds in some cases.

In “Stage Three”, the “Stage One” aluminum is completely or partially immersed in the “Stage Two” solution. Complete immersion of the “Stage One” aluminum in “Stage Two” solution is preferred.

In this stage the formation of aluminum chloride (AlCL₃) and water begins to occur. Within the context of this invention, the transition metal acts as a catalyst, which effects a change in the aluminum structure. In small amounts, the transition metal begins to react with the surface of the aluminum, loosening the aluminum particles. Wherein the aluminum reacts with the “Stage Two” acid (in this case HCl) creating the AlCL₃ complex containing trace amounts of transition metal in a loose formation.

Once the aluminum is submerged in the secondary acidic container, which is heat and acid resistant, containing “Stage Two” acid solution and transitional metal mixture. A halogen based acid such as HCL, and water, such as tap water or seawater, with a range of 1N-2N normality strength ratio, containing a transition metal, such as chromium III of about 5-20 grams to every 100 gallons as an example (or less than 0.01%) of the acid solution is preferred.

Whereas “Stage One” was preparation of the surface of the aluminum, the “Stage Two” acid solution containing transitional metal will react with the “Stage One” clean-surface aluminum producing the complex and subsequently the slurry as seen in FIG. 3. As the AlCL₃ is being formed, it is also reacts with the transition metal to form a new complex. Once reaction occurs, the aluminum complex (AlCL₃) will stay in suspension along with Al+, —Cl, H+ and —OH. This aluminum will also contain trace amounts of activated hexagonal silicon, which is the naturally occurring impurity from the aluminum.

Depending on the size of the aluminum work-piece 1 or the amount of acid solution 4 present, the formation of the slurry 6 can continue up to the entire consummation of the “Stage One” aluminum material. However, it is often advantageous to adjust and re-supply the acid solution 4 to maintain a consistent quality and quantity of the said solution throughout “Stage Three”.

In “Stage Three” the ongoing temperature should be between ambient and not more than about 25° C. to 30° C., and not to exceed about 40° C. or higher.

While the aforesaid temperature gradients are important when preparing for the subsequent formation of the additive complex, it should be noted that the acid solution itself could be formed using somewhat higher temperatures, on the order of up to about 40° C., and also starting with aluminum of slightly lower purity.

A proper reaction of “Stage Three” is indicated in the following sequence: the initial proper reaction is indicated by a quick and sudden increase in temperature and volatility, roughly up to about 40° C. As the reaction continues, the temperature will come down to about between ambient and not more than about 25° C. to 30° C. Visually, a white cloudy suspension forms intermittently during the beginning of the reaction. As the reaction stabilizes, the slurry begins to clear. Over the course of 10-14 days or potentially longer than 14 days depending on the level of activeness of the slurry, the slurry will increase in viscosity. In order to properly continue the reaction, careful attention should be made to the placement of the aluminum in the container, including movements of the aluminum if necessary, to assure the ongoing reactive state of the reaction.

As the reaction continues in “Stage Three”, the aluminum will be consumed and decrease in size. This is due to the consumption rate of the reaction. Although it is possible that the entirety of the aluminum can be used up in a single reaction or in a reactor given ample acid/water mixture and time. It is more likely that the reaction will stop on its own due to higher viscosity (10 cps to +20 cps, as an example). This slurry is not meant to reach such high levels of viscosity. During the reaction, there will be small amount of evaporation, containing trace amounts of hydrogen gas and water. As the reaction comes closer to meeting the necessary conditions, the color will change from clear/light green to a dark green. It should be noted, a continuous reaction can occur, if the containers are emptied and refilled with “Stage Two” solution, or if the slurry is drained out and refilled continuously, allowing for the aluminum to be completely consumed (FIG. 4).

In “Stage Three” of the reaction, the PH of the slurry is kept at a constant about 2-5 pH, and the normality of the slurry at about 1N to 2N not to exceed 3N. Not maintaining the correct pH and normality range will cause the reaction to stop and the process must then be restarted. Several different issues arise when the reaction stops. In order to restart the reaction, the pH and normality must be measured and subsequently balanced (PH 2-5; 1N-2N in normality) using water and/or acid. The aluminum can also be a factor in stopping the reaction of the slurry when it has attracted too much of the transitional metal in solution to the aluminum surface. In this case, the aluminum must be taken out of the “Stage Three” slurry and be placed in the original high strength acid container from “Stage One” (FIG. 1) in order to clean the surface again. Once cleaned, the aluminum can be brought back into the reactor of “Stage Three” and the reaction can restart and continue (FIG. 3). Of course there are multiple methods to accomplish the purpose of cleaning the surface of the aluminum. Such methods can include removing the acid solution from the reactor and adding into the reactor the stronger acid solution of “Stage One” to clean the surface of the aluminum, followed by reintroducing the “Stage Two” solution into the reactor in order for re-continued ongoing reaction. The adjustment of the pH and Normality, and re-supply of the acid, water, aluminum and potentially Chromium maintain a consistent quality and quantity of the reaction and the resulting slurry.

The next step in the process is maintaining the formation of the slurry (i.e., “Stage Four”). This includes adjusting and re-supplying the acid solution of “Stage Two” to maintain the same (i.e., a consistent) quality and quantity of the acid solution as in “Stage Two” and continue on to “Stage Three”.

During “Stage Three” and “Stage Four”, monitoring mechanisms can be included for monitoring electricity generated by the reaction; the gas released by the reaction; the temperature of the slurry and the temperature within the environment of the reactor containing the slurry; the volume of the slurry; the weight of the aluminum; visual observation of the state of reaction; in addition to pH, density and viscosity of the slurry. All such measurements combine together to insure a proper reaction and the judgment of the readiness of the subject invention additive slurry. A voltmeter can be used to monitor electrical activity, typically in the range of about 1.10 to 1.30 volts.

During “Stage Four”, the slurry approaches the desired density and viscosity, which is about 10 cps to 20 cps with the most desired range by the applicant to be about 11 cps to 17 cps, indicating the time for the collection of the ready slurry.

If desired, the collected ready slurry can be then “dehydrated” either by leaving in ambient environment or using a drying mechanism such as a drying oven or vent of some kind, to allow the evaporation of the moisture such as water content until the slurry turns into a gel and/or then further a solid state. This gel or solid material can be re-diluted re-hydrated with acid and water solution in proper ratio to turn it back into a liquid solution. It is to be noted that the drying process should not be subjected to high temperatures such as any temperatures as high or higher than possibly about 40° C. It could potentially reduce the effectiveness of the invention additive.

“Stage Five” is the Application Stage. This additive can be mixed into inorganic materials such as plastics, paint and coating, as examples. However, the applicant's focus here is in materials that contain some form of capillarity-porosity, such as wood and wood-based materials. Materials to be treated are not limited to textiles and fabrics; paper and paper products; wood and wood products. However, the description focuses mainly on plywood below for the purpose of explaining one method of the process of potential applications of this additive:
(a) Plywood is the preferred material of use in this example. The “wood-materials” used to make plywood can be treated before they are assembled into plywood allowing for the greatest absorption of the additive and accomplishing the best effectiveness. However, that is not to say that finished plywood could not be treated similarly. Already-assembled plywood can also be treated by absorbing the additive.
(b) Almost all of the plywood or wood-materials for making plywood can be submerged, sprayed, pressure treated or using other methods for the purpose of absorbing the additive slurry.
(c) Once the treated material absorbs enough additive slurry, which the percentage of absorption differs by the materials used. In the case of plywood, it is often observed that the subject test plywood would absorb about 20% by weight of the additive. The treated material is then dried either in ambient environment or by using a drying mechanism such as a drying vent or oven.
(d) Other materials such as paper, cardboard, or carton can be treated via submerging, spraying on or coating with the additive slurry. Early addition of the slurry to paper pulp formation offers the best effectiveness of the additive, as well as greater tensile strength. Cellulose pulp can be treated via submerging in the additive slurry. Once treated, it can be squeezed to remove excess slurry.
(e) Materials treated with this additive will char upon contact with a source of ignition but not ignite into flames, and will give off no toxic elements into the atmosphere.
(f) Timber and wood chips can be treated with a pressure or soaking process, allowing for a >=20% absorption. Rendering the timber fire resistant, fungi resistant, heat resistant and insect resistant, as well as overall increasing its tensile strength. Wood chips can be submerged or pressure treated accordingly and used for a wide variety of fire buffers, insect repellant or as insulators, as examples.
(g) Paints: In order to mix this additive with paints, the ideal pH must be created. The pH of the slurry is important when adding to paint and must be normalized so that the paint can mix properly with the additive. The paint containing this additive will have the effectiveness for fire retardant, fungi resistant and insect resistant.
(h) Plastics such as PVC: Early on during polymerization, this invention additive can be added into the raw materials such as the plasticizer. Temperature and speed of mixing will need to be carefully monitored in this case. Additionally, the pH must be controlled in order to correctly form the PVC.
(i) Drywall/Gypsum: Early on during the initial mixing of the gypsum with water before the formation of the boards, this invention can substitute water in the formulation of the gypsum drywall, increasing the strength and resistance of the said gypsum drywall. The same scenario can be applied to cement based and asphalt based products.

“Stage Six” is the last and also the final Drying Stage. Treated materials such as the subject additive treated wood will then need to be dried. The applicant is using treated wood in this instance for the purpose of explaining this drying process. However, the drying process is not limited to this method only.

In “Stage Six”, the drying of the additive-treated wood takes place. Treated materials are quickly submerged in a drying agent for a short period of time, such as several seconds to several minutes, to cover the entire surface of the subject material. Magnesium Sulfate (MgSo₄) agent or Potassium Hydroxide (KoH) agent can be used as the drying agent, though the choices of drying agent are not limited to only these options.

The drying agent can be prepared in a diluted mixture with ratios including but not limited to, for example, a 4:1 ratio (drying agent to water), or full strength drying agent sometimes can also be used.

Once treated with the drying agent, the treated materials can then be dried, either in the ambient environment or by using a drying mechanism such as the drying vent, fan or oven.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

### BRIEF DESCRIPTION OF THE DRAWINGS

FIG. 1: A schematic view of Stage One.

The cleaning and deoxidizing of the surface of the Aluminum 1 in the presence of a strong halogen acid and water solution 2 with strength of about 3 normality, +−1 normality, in an acid and heat resistant container 3.

FIG. 2: A schematic view of Stage Two.

A secondary halogen acid and water solution 4 of normality about 1N to 2N, is mixed with a transitional metal including chromium (III) 5 as a preferred choice, inside an acid and heat resistant container 3.

FIG. 3: A schematic view of Stage Three.

The aluminum 1 is submerged in the secondary acid bath 4 containing the transitional metal 5 (4+5), and the formation of the aluminum complex begins. Included the light green coloring of the initial reaction.

FIG. 4: A Schematic view of Stage Four.

The aluminum complex/slurry 6, which is the result of Aluminum 1 reacting in Solution (4+5) creating this complex/slurry 6, has reached its final condition. Included is the aluminum 1 being consumed but not yet completely during the reaction. Additionally the darker green color is one of the signs showing the slurry is near completion.

FIG. 5: A schematic view of the overall suggested process for manufacturing on a pilot or industrial scale.

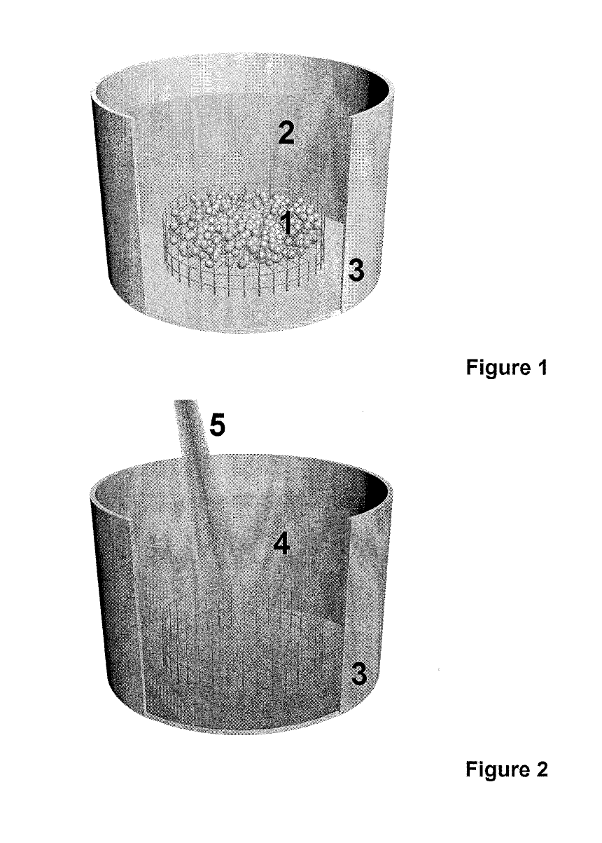

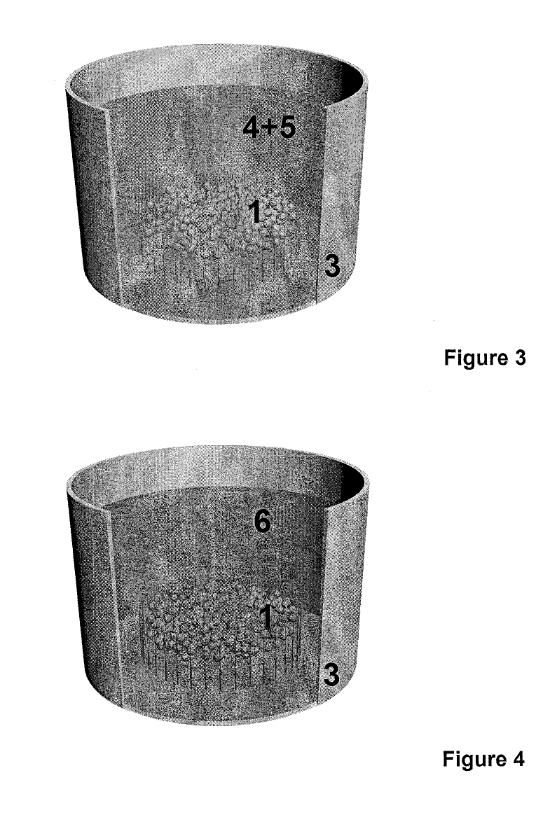

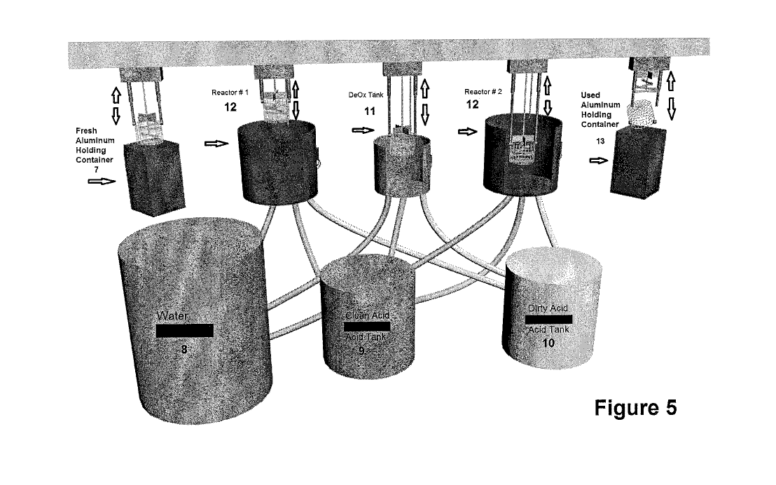

Including:
Fresh aluminum holding container 7;
Water container 8;
Clean acid container 9;
Dirty acid container 10;
De-oxidation container 11;
Reactor 12;
Used aluminum container 13.

1-67. (canceled)

68. A non-toxic slurry comprising aluminum, a transitional metal, a halogen acid and water, wherein when applied to a material, the material is rendered fire retardant, heat resistant, fungal resistant, insect resistant and has improved strength and durability, as compared to the material alone.

69. The non-toxic slurry in claim 68 wherein the aluminum is in a pure form, and its purity is approximately 99.90% to 99.99% by weight.

70. The non-toxic slurry in claim 68 wherein the transition metal includes chromium.

71. The non-toxic slurry in claim 70, wherein said chromium is chromium (III) in the amount of 5-20 grams to 100 gallons of the acid solution formed of the halogen acid and water.

72. The non-toxic slurry in claim 71, wherein the chromium (III) is in a substantially pure form.

73. The non-toxic slurry in claim 68 wherein the halogen acid comprises hydrochloric or muriatic acid.

74. The non-toxic slurry in claim 73 wherein the halogen acid exhibits a strength of 28% or higher.

75. A method of producing a non-toxic slurry, comprising the steps of:
Submerging and reacting aluminum metal with a strong acid solution including a halogen acid and water solution to remove oxide surface coatings and inhibit the oxidation of the surface,
wherein the strong acid solution completely covers the aluminum metal.

76. The method of claim 75, wherein the aluminum in a pure form of about 99.90% to 99.99% by weight of purity.

77. The method of claim 75, wherein the aluminum is in the form of pellets, ingots, rods or other shapes and forms.

78. The method of claim 75, wherein the aluminum is a singular piece or multiple pieces.

79. The method of claim 75, wherein the strong acid and water solution exhibits approximately 2 to 4 normality.

80. The method of claim 79, wherein the normality is 3.

81. The method of claim 75, wherein the amount of aluminum to acid solution ratio is less than approximately 2:3 by volume.

82. The method of claim 75, wherein aluminum to acid solution ratio is approximately 1:3 by volume.

83. The method of claim 75, wherein further comprising mixing a trace amount of transitional metal including chromium (III) into a mild acid solution including halogen acid and water.

84. The method of claim 83, wherein the acid water solution exhibits a normality of 1 to 2 normality.

85. The method of claim 84, wherein the aluminum is immersed into the acid water solution mixed with trace amounts of transition metal including chromium (III).

86. The method of claim 75, further comprising the steps of adjusting and maintaining the pH of the slurry to about pH 2 to 5.

87. The method of claim 86, wherein the acid is a halogen acid.

88. The method of claim 87, wherein the acid includes hydrochloric acid.

89. The method of claim 86, wherein the slurry is adjusted to maintain an active reaction.

90. The method of claim 89, wherein the slurry is adjusted by repeating the steps of submerging and reacting aluminum metal with an acid solution to maintain the pH level of the slurry at a pH level of 2 to 5.

91. The method of claim 85, wherein the slurry is adjusted by continued agitation of the surface of the immersed aluminum.

92. The method of claim 91, wherein the surface of the aluminum is agitated by continuously brushing the surface of the aluminum manually or mechanically.

93. The method of claim 91, wherein the by surface of the aluminum is agitated by continuously moving aluminum pieces comprising the aluminum manually or mechanically.

94. The method of claim 91, wherein the surface of the aluminum is agitated by rubbing action of multiple aluminum pieces

95. The method of claim 75, further comprising the step of collecting the slurry formed by the reaction of the aluminum metal and acid solution.

96. The method of claim 95, further comprising testing the slurry with a density meter to determine when the slurry is in a form for collection.

97. The method of claim 96, wherein the slurry is in a form for collection when the density meter achieves a density reading 10-20 cps.

98. The method of claim 96, wherein the time to produce the slurry for collection is approximately 10-20 days.

99. The non-toxic slurry of claim 68, wherein said aluminum comprises about 1% to 6% by weight of said additive.

100. The method according to claim 75, to produce a non-toxic slurry that renders treated material fire resistant.

101. The method according to claim 75, to produce a non-toxic slurry that renders treated material heat resistant.

102. The method according to claim 75 to produce a non-toxic slurry that renders treated material resistant to fungus, mold and mildew.

103. The method according to claim 75 to produce a non-toxic slurry that renders treated material insect resistant.

104. The method according to claim 75 to produce a non-toxic slurry that renders treated material with increased strength.

105. The method according to claim 75 to produce a non-toxic slurry that renders treated material with improved durability.

106. The method according to claim 75 to produce a non-toxic slurry that renders treated material with extended life of usage.

107. A method of applying the non-toxic slurry of claim 68, wherein the non-toxic slurry is applied to a material with one single application.

108. The method of claim 107, wherein the non-toxic slurry is applied to wood, wood-based products, textile, plastics, wallboards, paper and paper products, paints and coatings, insulation materials, cement and asphalt, materials that are organic or inorganic and that are either porous or can be mixed with liquid based materials.

109. A method of applying the non-toxic slurry of claim 68 to a treated material by immersing or spraying the treated material in the non-toxic slurry or by pressure treating the treated material with the non-toxic slurry.

110. The method of claim 109, further comprising drying the treated material in room temperature atmosphere.

111. The method of claim 109, further comprising drying the treated material with a drying vent or oven.

112. The method of claim 109 further comprising drying the treated material by immersing the non-toxic slurry-treated material in solutions containing magnesium sulfate or potassium hydroxide (MgSO₄ or KOH).
